(19) United States
(12) Patent Application Publication
(10) Pub. No.: US 2020/0284151 A1
(43) Pub. Date: Sep. 10, 2020

(54) MODIFIED AIRFOIL FOR HORIZONTAL-AXIS WIND TURBINE AND AIRCRAFT

(71) Applicants: Ranbir S. Sahni, Long Beach, CA (US); Hamid R. Rahai, Long Beach, CA (US)

(72) Inventors: Ranbir S. Sahni, Long Beach, CA (US); Hamid R. Rahai, Long Beach, CA (US)

(21) Appl. No.: 16/811,984

(22) Filed: Mar. 6, 2020

Related U.S. Application Data
(60) Provisional application No. 62/815,892, filed on Mar. 8, 2019.

(51) Int. Cl. F01D 5/14

(52) U.S. Cl. CPC F01D 5/14; F05D 2220/30

(57) ABSTRACT

A horizontal axis wind turbine airfoil segment with vortex generator tape (“VGT”) tape applied downstream of the leading edge and within the boundary layer is disclosed. Placing the VGT tape at distance of 60% chord results in the boundary layer profiles displaying increased momentum near the edge of the boundary layer. Tests show that the contribution of vortices generated from VGT tape cause the increased momentum within the boundary layer. Moreover, a reduced skin friction coefficient is observed with the tape and the pressure coefficient on the suction side display reductions further downstream of the chord length. Using the total drag, the present invention has produces up to 8% reduction in in drag coefficient and about 2% increase in lift coefficient for the airfoils.

### CROSS-REFERENCES TO RELATED APPLICATIONS

This application claims priority from U.S. Provisional Patent Application No. 62/815,892, filed Mar. 8, 2019, the content of which is incorporated by reference herein in its entirety.

### BACKGROUND

Objects in the path of an airstream experience a downwind force called drag. Some of the earliest wind turbine designs utilized this force and are known as vertical axis wind turbines (VAWT). While drag is easy to harness, VAWTs produce limited output compared to horizontal axis wind turbines (HAWT) because as the blades rotate, one half of the rotor is always travelling upwind against the force of the airstream in order to turn the blades into a position to harness the downwind drag again. Wind produces another force called lift, which always operates at a right angle to the wind direction and is the force utilized by HAWT designs.

The amount of energy that can be harnessed by a wind turbine rotor ultimately depends on the rotor size or ‘swept area’, the wind speed, the air density in the wind stream, and the turbine's efficiency. Similar to a sail, the larger the rotor's swept area, the more wind energy it can harness. If one doubles the rotor's swept area, then the subsequent power potential increases by a factor of two. If the wind speed doubles, the power potential increases by a factor of eight; rotor size and wind velocity are the two main determining factors for theoretical power potential. An approximation of theoretical power potential from a wind stream at a given speed can be calculated with the following equation:

P=½ρAV³

where:
P=power in watts;
ρ=density of the air in the wind stream in kg per cubic meter;
A=rotor swept area in square meters=πr²
V=wind velocity in meters per second.

A turbine's overall efficiency also has a major effect on potential power. Performance from horizontal axis wind turbines are limited by Betz's law. According to Betz's law, no HAWT can capture more than 59.3% of the kinetic energy in a wind stream. The factor 16/27 (0.593) is known as Betz's coefficient, or the Betz limit. Practical utility-scale wind turbines achieve at peak 75% to 80% of the Betz limit, so a reasonable approximation for an actual coefficient would be between 20% for do-it-yourself and up to 45% for a professionally manufactured turbine, and is incorporated and expressed in the above power equation as:

P=½ξpAV³

where ξ=turbine coefficient=˜35%.

The most effective approach to the airfoil, or blade, design utilizes blade element momentum theory (BEMT), which combines blade element theory with momentum theory. The theory divides the span of a turbine blade into multiple elements to calculate the local forces on each section of the blade at a specific wind speeds, to establish optimal chord width, thickness, and twist distributions.

Inefficiencies in airfoils also impact commercial aircraft, a multi-billion dollar industry. Despite operating at transonic speeds (˜0.85M as opposed to subsonic speeds for HAWTs), the present invention works well on aircraft wings to reduce the drag and improve the airfoil characteristics, which can lead to improved fuel economy. Any increase in the efficiency of these aircraft, even modest increases, can save the airlines hundreds of millions of dollars every year. The present invention provides an airfoil that can improve efficiency for both wind turbines and aircraft.

### SUMMARY OF THE INVENTION

Wind power systems, which generate clean energy, have great potentials to strengthen the energy independence of the U.S. and reduce environmental pollution. Commercial wind farms employing horizontal-axis wind turbines (HAWTs) enjoy a robust growth, however, they still account for less than 7% of the total electric power generated in the U.S. Increasing efficiency and power production of these turbines results in additional power production. The present invention incorporates the placing of vortex generator tape (“VGT”) tape within the boundary layer of a wind turbine airfoil for drag reduction, improved L/D (lift to drag ratio) and eventual increased in power production.

Numerical investigations of a two-dimensional airfoil segment of the NASA high lift common research model (HL-CRM) have also been performed with and without the vortex generator tape (VGT) attached across the width of the suction side (upper surface) of the airfoil at zero angle of attack (AOA). The airfoil of the present invention incorporates a VGT tape 15 cm in width and 2 mm in thickness, at 60% of the chord of the airfoil. Analyses were performed at Mach 0.85 which is a typical cruise speed of commercial aircraft, and the results indicate with the present invention there was nearly a 2% improvement in the lift coefficient and 5% reduction in drag coefficient, resulting in more than a 7% increase in lift to drag coefficients.

These and other features of the present invention may best be understood with reference to the drawings and the detailed description of the preferred embodiments below.

### BRIEF DESCRIPTION OF THE DRAWINGS

FIG. 1A is an elevated, perspective view of a HAWT of the type where the present invention is used;

FIG. 1B is an elevated, perspective view of an aircraft of the type where the present invention is used;

FIG. 1C is a sectional view of an airfoil such as might be used in the applications of FIGS. 1A and 1B;

FIG. 1D is a cross sectional view of the airfoil of FIG. 1C;

FIG. 1E is an enlarged sectional view of the trailing edge of the vortex generating tape;

FIG. 2 is a table of variations of lift and drag coefficients and their ratios;

FIG. 3 is a plot of experimental variation of drag coefficient for multiple airfoil configurations;

FIG. 4 is a table of numerical results of lift and drag coefficients at 8° AOA;

FIG. 5 is a table of experimental drag coefficients at 8° AOA;

FIGS. 6 and 7 are contours of axial mean velocity of HL-CRM airfoil with (a) No CVG, (b) with CVG and mesh 1, (c) with CVG and mesh 2;

FIGS. 8 and 9 are contours of axial mean vorticity of HL-CRM airfoil with (a) No VGT; (b) with VGT and mesh 1; and (c) with VGT and mesh 2; and

FIG. 10 is a table summarizing the drag and lift coefficients of the testing.

### DETAILED DESCRIPTION OF THE PREFERRED EMBODIMENTS

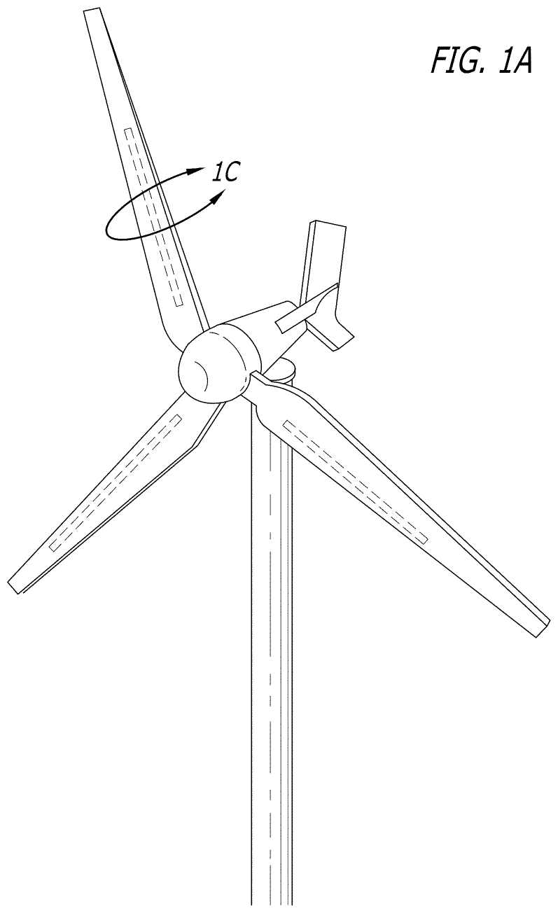

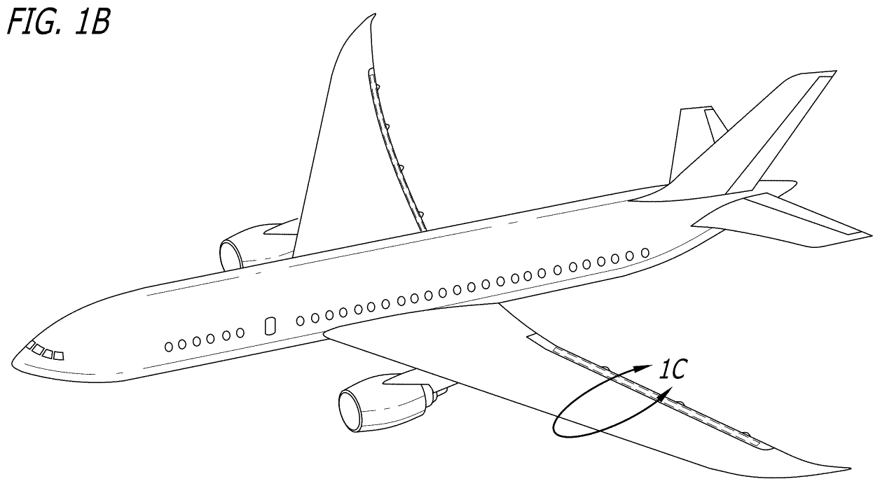

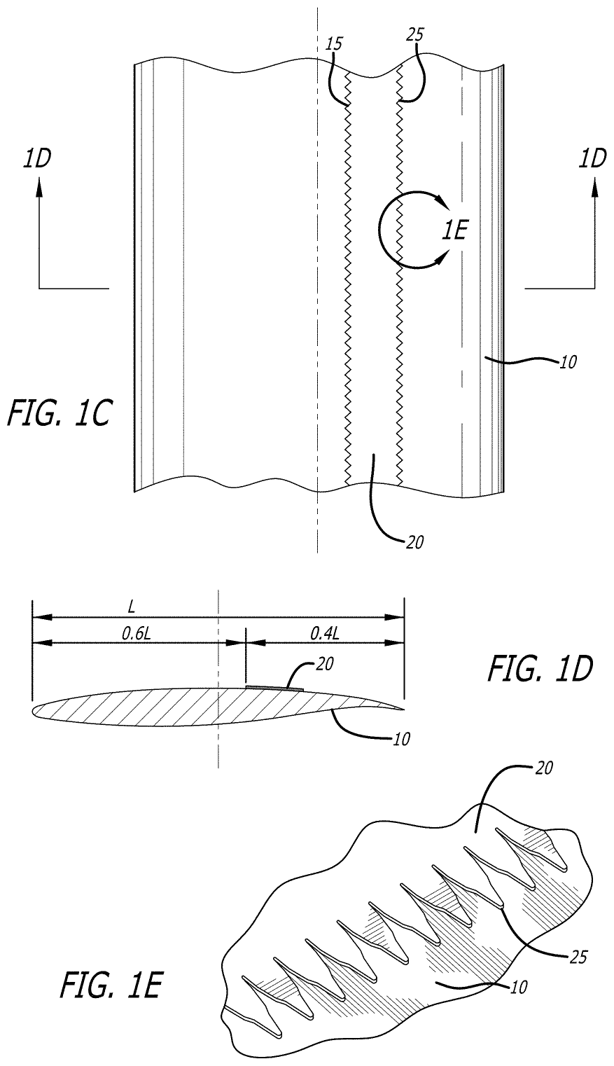

FIGS. 1A and 1B show a HAWT and an aircraft of the type that use airfoils to generate lift. FIG. 1C illustrates a sectional view of the upper surface of one such airfoil 10 that includes on the upper surface a sheet of vortex generator tape (“VGT”) tape 20 applied downstream of the leading edge and within the boundary layer. As shown in FIG. 1D, the VGT tape 20 is located at a distance of 60% chord length. In a first preferred embodiment, the tape is placed between 0.5 and 0.80 of the chord length, and in another preferred embodiment, the tape is placed between 0.6 and 0.7 of the chord length. The presence of the VGT tape results in the boundary layer profiles displaying increased momentum near the edge of the boundary layer. In another preferred embodiment, the tape 20 is cut so as to include a sawtooth leading edge 15 and a sawtooth trailing edge 25. The sawtooth can take the form of repeating cycles of a wider base transitioning non-linearly to a narrow apex as best seen in FIG. 1E. Tests show that the contribution of vortices generated from VGT tape cause the increased momentum within the boundary layer. Moreover, a reduced skin friction coefficient is observed for 1 and 2 mm tape and the pressure coefficient on the suction side display reductions further downstream of the chord length. Using the total drag, with 1 and 2 mm VGT tape, the present invention has been shown to produce up to 8% reduction in in drag coefficient and about 2% increase in lift coefficient for the airfoils. The C_{L}/C_{D} ratio shows an 8-10% improvement.

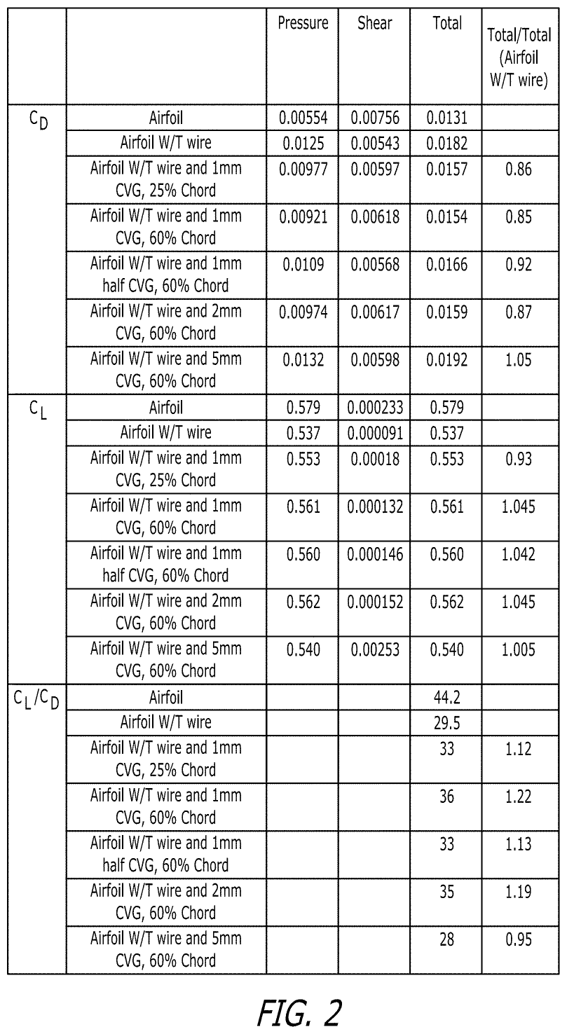

FIG. 2 is a table showing a summary of computational fluid dynamics analysis for the present invention. During the testing of the invention, trip wires were placed at the leading edge of the airfoil to generate a turbulent boundary layer simulating high turbulence atmospheric conditions. With 1 mm VGT tape at 25% chord, the skin friction coefficient decreases and the suction side of the airfoil experiences a reduction in the pressure coefficient Cₚ, which results in an improved lift coefficient C_{L}. The overall results indicate about 8% reduction in skin friction and nearly 10% increase in L/D when VGT is in place, with trip wire.

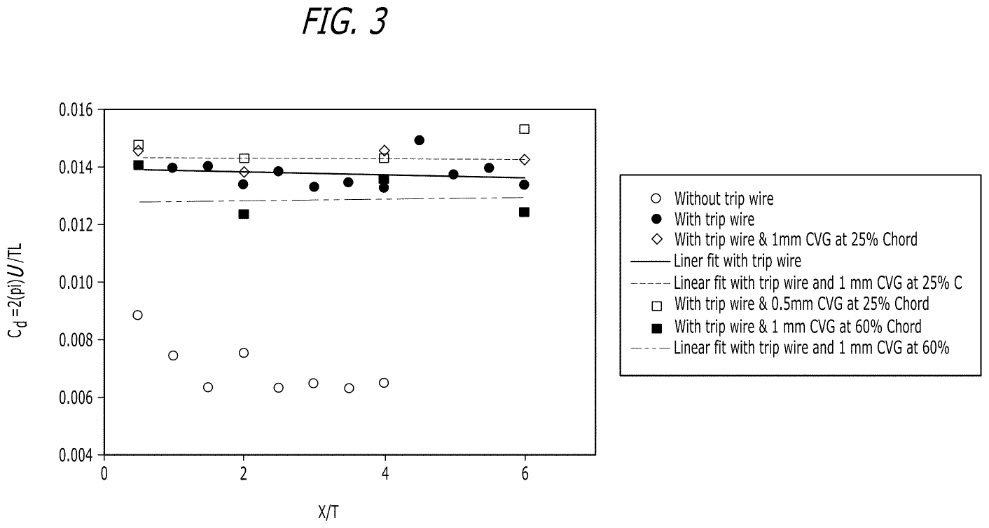

FIG. 3 shows a plot of the coefficient of drag as a function of wake momentum thickness. For VGT tape placed at 60% chord, an 8%-10% reduction in drag coefficient was obtained which is consistent with corresponding numerical results.

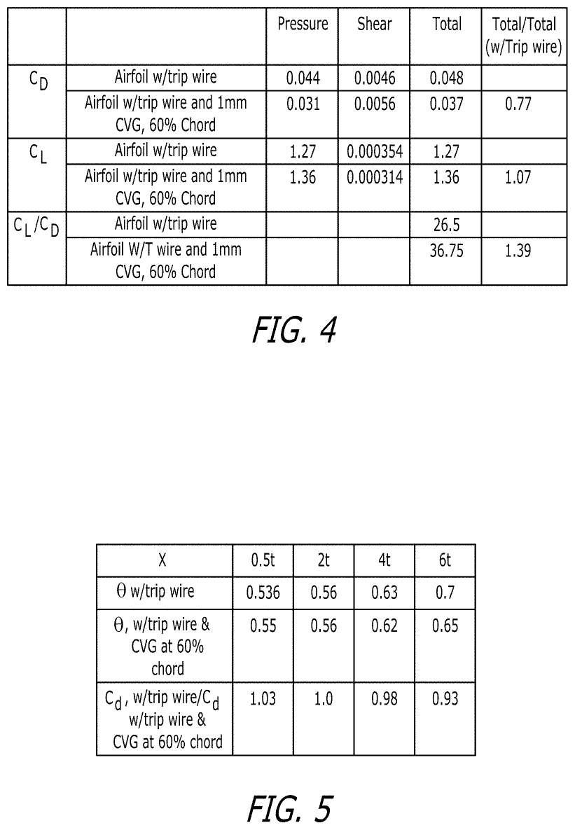

FIG. 4 is a table reporting the numerical results of Lift and Drag Coefficients and their ratio at an eight degree angle of attack orientation of the airfoil. FIG. 5 is a table reporting the experimental drag coefficient at the eight degree angle of attack position of the airfoil.

The present invention can be used in a modified horizontal axis wind turbine airfoil with a VGT tape applied on the chord downstream of the leading edge. Computational fluid dynamics and experimental investigations of a NASA 633-618 airfoil similar to that used for development of a GE 100KW horizontal-axis wind turbine have verified the energy savings and improved efficiency of the present invention. Testing with and without the VGT tape attached across the width of the suction side (upper surface) of the airfoil at 12 and 22 miles per hour (MPH) was performed, and the results indicate that for VGT tape thickness of 1 mm-2 mm, placed between 25% to 60% of the chord at zero angle of attack (AOA), an 8%-17% reduction in overall drag coefficient and up to 2% improvements in lift to drag (L/D) ratio are obtained. Using the experimental results, increasing AOA to 8 degrees results in up to a 7% reduction in drag coefficient and improvements in lift resulting in nearly 10% improvement in the lift to drag ratio. Based on these results, the estimated maximum increase in power output is approximately 3%-5% at zero AOA and higher power output at moderate AOA. Similar numerical analyses were performed for a two-dimensional NASA HL-CRM.

A numerical model of the airfoil and the VGT tape with the meshes used was used to test the benefits of the present invention. In the far-field, unstructured polyhedral mesh was used, while in the near field 18 prism layers with a minimum wall thickness of 4.3×10⁻⁶ meter (0.0043 mm) for a total width of 15 cm was employed. The airfoil had chord and span dimensions of 6.03 M and 1.22 M, respectively. Split bodies (flaps, slats) were manually attached to construct the model airfoil for analyses. Reynolds Averaged Navier-Stokes (RANS) along with k-ε realizable turbulence model and two-layer all Y⁺ wall treatment were used in all computations.

When VGT was attached, two different meshes were used. For both meshes the same 18 prism layers and prism layer thickness and base size mesh of 5 meters were used. However, for mesh 1 (coarse mesh) volume control was 4% of the base size, while for mesh 2 (fine mesh) the volume control was reduced to 1.3% of the base size. Thus for mesh 1, the cell number was 9.95 million, while for mesh 2, it was 16.5 million.

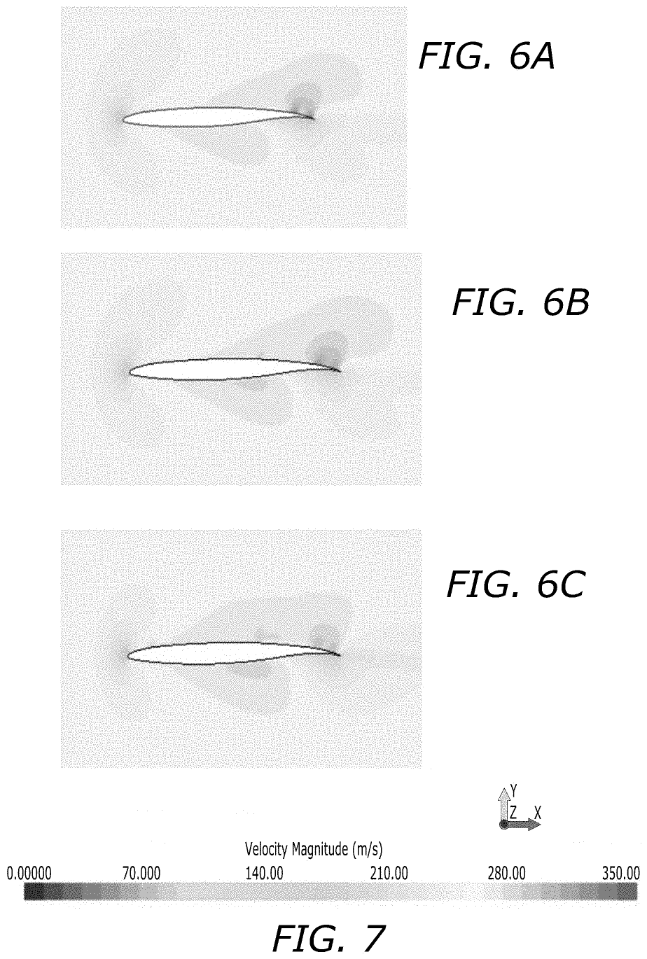

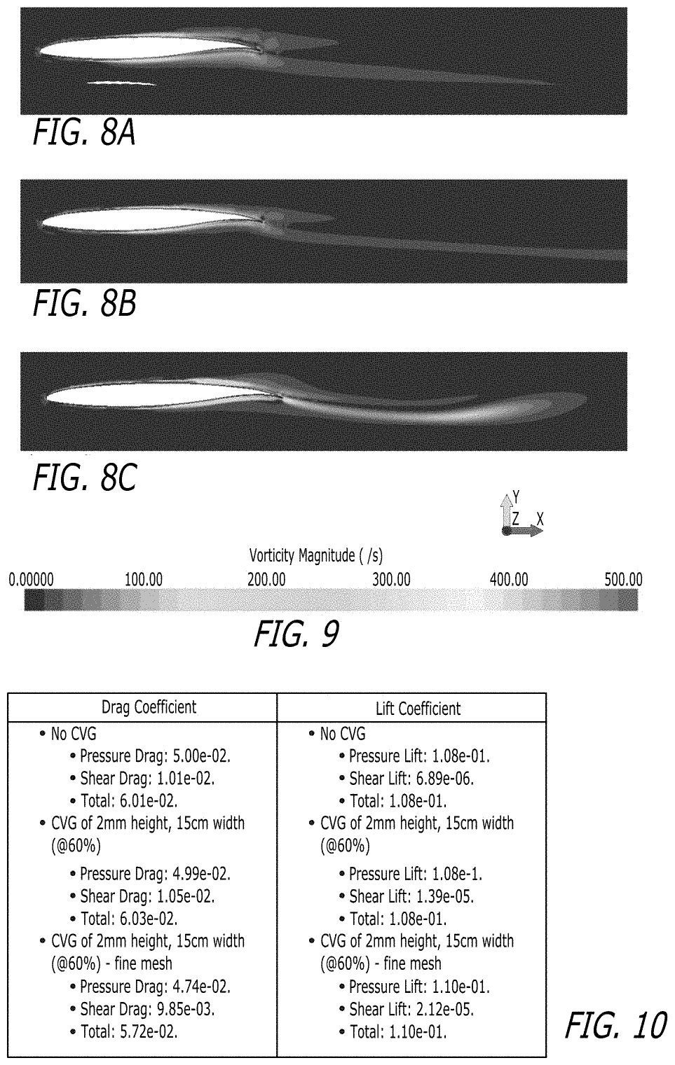

FIGS. 6 and 7 show contours of the mean pressure, and FIGS. 8 and 9 show the mean vorticity for the three cases of the baseline airfoil with no VGT and the same contours with VGT, using meshes 1 and 2. With finer mesh and increased number of cells, better resolutions of flow characteristics were obtained near the surface. With the VGT in place, with mesh 2 (finer mesh), there were increased vorticity and reduced pressure drag, resulting in reduced overall drag coefficient. As expected, the role of VGT is seen to increase vorticity near the surface, increasing momentum in this area, resulting in near wake modification and thus reduced drag force. Increased vorticity is observed in the wake of the airfoil when finer mesh (mesh 2) was used.

FIG. 10 is a table showing details of the aerodynamic parameters. Overall, with VGT, there is a nearly 5% increase in lift to drag coefficients with a VGT tape thickness near 1 mm.

The foregoing demonstrates that improved performance can be obtained on airfoils for both aircraft and HAWTs using a turbulent boundary layer with VGT tape positioned downstream from the leading edge at approximately sixty percent of the chord. This results is lower drag and improved lift, and can significantly improve the efficiency of the airfoil in both the HAWT and aircraft environment.

We claim:

1. An airfoil for use with a horizontal axis wind turbine, comprising:
an airfoil having a leading edge, a trailing edge, an upper surface, and a trailing surface, and a chord length measured between the leading edge and the trailing edge; and
a vortex generating tape applied to the upper surface of the airfoil at a distance of greater than or equal to 0.5 of the chord length.

2. The airfoil of claim 1, wherein the vortex generating tape has a thickness of no greater than two millimeters.

3. The airfoil of claim 1, wherein the vortex generating tape is applied at between 0.6 of the chord length and 0.8 of the chord length.

4. The airfoil of claim 1, wherein the vortex generating tape is cut to have a sawtooth leading edge.

5. The airfoil of claim 4, wherein the vortex generating tape is cut to have a sawtooth trailing edge.

6. The airfoil of claim 4, wherein the vortex generating tape is cut to have repeating cycles of a wider base transitioning non-linearly to a narrower apex.

7. An airfoil for use with an aircraft, comprising:
an airfoil having a leading edge, a trailing edge, an upper surface, and a trailing surface, and a chord length measured between the leading edge and the trailing edge; and
a vortex generating tape applied to the upper surface of the airfoil at a distance of greater than or equal to 0.5 of the chord length.

8. The airfoil of claim 7, wherein the vortex generating tape is applied at between 0.6 of the chord length and 0.8 of the chord length.

9. The airfoil of claim 7, wherein the vortex generating tape is cut to have a sawtooth leading edge.

10. The airfoil of claim 9, wherein the vortex generating tape is cut to have a sawtooth trailing edge.

11. The airfoil of claim 7, wherein the vortex generating tape is cut to have repeating cycles of a wider base transitioning non-linearly to a narrower apex.
